(19) United States
(12) Patent Application Publication
(10) Pub. No.: US 2016/0195931 A1
(43) Pub. Date: Jul. 7, 2016

(54) OPERATING DEVICE WITH HAPTIC FEEDBACK

(71) Applicant: VOLKSWAGEN AG, Wolfsburg (DE)

(72) Inventors: Mark Peter CZELNIK, Wolfsburg (DE); Michael KLAAS, Schwulper (DE); Carsten RIEGER, Lengede (DE)

(21) Appl. No.: 14/987,833

(22) Filed: Jan. 5, 2016

(30) Foreign Application Priority Data
Jan. 5, 2015 (DE) 10 2015 200 037.0

(51) Int. Cl. G06F 3/01; G06F 3/0488; G06F 3/0481; G06F 3/041; G06F 3/16

(52) U.S. Cl. CPC G06F 3/016; G06F 3/0414; G06F 3/167; G06F 3/0416; G06F 3/0481; G06F 3/04883

(57) ABSTRACT

Touch-sensitive operating apparatuses having a touchscreen which generates a haptic feedback in the event of an actuation of a virtual operating element and methods for operating functions. The method includes representing a virtual operating element on a display surface, detecting touch positions on a touch surface of a touch-sensitive position detection apparatus, detecting press-on forces in the event of a touching actuation of the touch surface, evaluating the detected touch positions and press-on forces, determining whether a correct haptic actuation of the virtual operating element is present, initiating a function assigned to the at least one virtual operating element, and generating a haptic feedback at the touch surface. The operating apparatus has a haptic controller which, on the basis of the press-on forces determined, generates two different haptic feedbacks in the event of an actuation process of a virtual operating element.

### PRIORITY CLAIM

This patent application claims priority to German Patent Application No. 10 2015 200 037.0, filed 5 Jan. 2015, the disclosure of which is incorporated herein by reference in its entirety.

### SUMMARY

Illustrative embodiments relate to touch-sensitive operating apparatuses comprising a touchscreen which generate a haptic feedback in the event of an actuation of a virtual operating element.

### BACKGROUND

In modern motor vehicles a multiplicity of functions and vehicle systems need to be operated. Since structural space in the vehicle is limited and, consequently, an individual operating element assigned to the specific functions and to the vehicle system cannot be embodied and arranged for every vehicle system and every vehicle function, it is customary nowadays for a multiplicity of such vehicle systems and operating functions to be operated or made operable via a multifunction display and operating apparatus. Such multifunction display and operating apparatuses, which are typically arranged in a center console of a motor vehicle, generally comprise a freely programmable display surface and physically embodied operating elements such as pushbuttons, rotary pulse generators or the like arranged adjacent to the display surface. By means of a graphical representation on the freely programmable display surface, functions assigned to the individual physically embodied operating elements in different display and operating contexts can be displayed graphically. Such graphical representations are referred to as operating element assignments.

In developments of the display and operating apparatuses, a touch-sensitive position detection apparatus is assigned to the freely programmable graphical display surface. In this case, positions on a touch surface of the touch-sensitive position detection apparatus correlate with positions on the graphical display surface. If the touch surface of the touch-sensitive position detection apparatus is embodied as transparent and is arranged in front of the display surface, then the combination of freely programmable display surface and touch-sensitive position detection apparatus is referred to as a touchscreen.

While a user, in the event of an actuation of a physically embodied operating element, for example a pushbutton, obtains haptic feedback upon reaching a stop or upon snapback of a trigger mechanism, the haptic feedback also enabling blind operation of buttons particularly in motor vehicles, such a haptic feedback is not realized in conventional touchscreens.

Illustrative embodiments provide an improved operating apparatus with which, in particular, blind operation by a user is improved.

### BRIEF DESCRIPTION OF THE DRAWINGS

Disclosed embodiments are explained in greater detail below with reference to the drawings, in which:

FIG. 1 shows a schematic illustration of an operating apparatus and the arrangement thereof in a motor vehicle;

FIG. 2 shows a schematic illustration of a haptic controller;

FIG. 3 shows a schematic exploded view of individual constituent parts of an operating unit;

FIG. 4 shows a schematic view of a touchscreen with parts of the holding apparatus;

FIG. 5 shows a schematic view of at least one disclosed embodiment of an apparatus in which an actuator system acts in the actuation direction, a touchscreen not being included for reasons of clarification;

FIG. 6 shows a schematic illustration of drive electronics and of a mounting plate;

FIG. 7 shows a perspective rear view of an assembled operating unit;

FIG. 8 shows a schematic illustration for elucidating the force measurement with strain gages;

FIG. 9 shows a further perspective view for elucidating the force measurement by means of strain gages;

FIG. 10 shows a schematic illustration for elucidating the force measurement by means of an inductive measurement method;

FIG. 11 shows a schematic illustration for elucidating a compressive force measurement by means of a plate capacitor;

FIG. 12 shows a schematic illustration of the required press-on force which is necessary for bringing about a deflection;

FIG. 13 shows a schematic illustration for elucidating the actuation forces occurring during operation plotted against time and an assignment of the deflection to the forces occurring;

FIG. 14 shows a schematic illustration for elucidating the actuator driving signal and the resultant deflection of the touch surface and the temporal synchronization of a sound signal;

FIGS. 15a and 15b show different resulting deflection curves of the touch surface for different dampings;

FIG. 16 shows a schematic illustration for elucidating the division of the controller among different controller devices,

FIG. 17 shows a schematic illustration of local controller devices for the operation of an operating unit;

FIG. 18 shows a schematic illustration for elucidating the realization of an operating apparatus which has a complex human-machine interface logic;

FIG. 19 shows a comparison of the latencies that occur for at least one disclosed embodiment in which the controller is realized locally in individual control devices without the use of a central computer, and a controller which additionally uses a central computer;

FIG. 20 shows a schematic illustration of an interface between a central computer and the controller devices locally linked to the operating unit;

FIG. 21 shows a schematic illustration of the exchanged message diagrams in at least one disclosed embodiment in which part of the controller is implemented with a central computer;

FIG. 22 shows a schematic illustration of the messages in at least one disclosed embodiment in which the controller of the haptic feedback is realized in local control devices of the operating unit; and

FIG. 23 shows a schematic illustration of an apparatus with an operating apparatus.

### DETAILED DESCRIPTION OF THE DISCLOSED EMBODIMENTS

Disclosed embodiments evaluate, besides the touch position, the touch force or press-on force exerted by an actuation element perpendicular to the touch surface, to make it easier for the user to operate a virtual operating element for which a graphical representation is represented on the display surface. It is provided that the detected press-on force is compared with a first force threshold value and, in the event of the first force threshold value being reached or exceeded by the detected actuation force or press-on force, a first haptic feedback is communicated back to the user via the touch surface. The first haptic feedback is intended to convey to the user that the user has depressed the virtual operating element with a sufficient actuation force, such that a function initiation can then take place. Furthermore, the actuation force or press-on force is compared with a second force threshold value, which is lower than the first force threshold value. If, after the first force threshold value has been exceeded by the press-on force determined, it is undershot again by the press-on or actuation force determined, then a second feedback, which is different from the first haptic feedback, is output to the user via the touch surface of the touch-sensitive position detection apparatus. This feedback scheme experienced by the user corresponds to the greatest possible extent to that haptic perception which a user experiences upon the actuation of a physically embodied button. The first haptic feedback corresponds, for example, to pressing an operating element against a stop, and the second haptic feedback corresponds to the haptic feedback that occurs for example as a result of an elastic element springing back when a mechanical button is released. The disclosed apparatus and the disclosed method for detecting a user input via a touch-sensitive position detection apparatus coupled to a display apparatus convey a haptic feedback which is modeled as closely as possible on that of a mechanical operating element, such that blind operation is possible simply and reliably by a user, in particular without devoting gaze attention thereto.

### DEFINITIONS

For purposes of the present disclosure, an operating apparatus is understood to be an apparatus for detecting a user's input. Apparatuses referred to as display and operating apparatus are also considered to be an operating apparatus here.

Operating unit denotes that part of an operating apparatus which is embodied on or in the housing in which the physically embodied device for user detection is embodied, the device being used for detecting a user input. In the case of an operating apparatus with which a user input is effected via a touching actuation of a touch-sensitive position detection apparatus the operating unit comprises all components which are embodied in the housing or on the housing in or on which a touch surface of the touch-sensitive position detection apparatus is arranged, including the housing.

A freely programmable display apparatus is deemed to be an apparatus having a display surface in which a wide variety of items of information can be graphically represented temporally successively at the same position of the display surface. Since this takes place in a manner controlled by means of a program-controlled device, the text makes reference to a freely programmable display apparatus. A display surface of such a freely programmable display apparatus is referred to as a freely programmable display surface.

A touch-sensitive position detection apparatus is an apparatus which has a touch surface, which is generally embodied such that it is planar and smooth, and which is designed to determine a location of a touch by an actuation element. Such a location determined is referred to as touch position. Touch-sensitive position detection apparatuses that are able to detect a plurality of touch positions simultaneously are referred to as multiply touch-sensitive position detection devices or else as multi-touch-enabled apparatuses. The latter constitute a subgroup of the touch-sensitive position detection apparatuses.

If the touch surface is embodied as transparent and coupled to a freely programmable display surface arranged behind it, then the overall apparatus is referred to as a touchscreen. In this case, too, there is once again classification into singularly touch-sensitive touchscreens and multiply touch-sensitive touchscreens, which can detect a plurality of touch positions of actuation elements simultaneously.

Actuation element denotes an article which is suitable for actuating the touch-sensitive position detection apparatus. This generally involves a body part, for example an extended finger, optionally an index finger. Alternatively, however, a stylus or other article can also serve as an actuation element.

Virtual operating element denotes the configuration of an operating element via a freely programmable display surface in conjunction with a touch-sensitive position detection apparatus. In this case, a graphical representation on the display surface is generally assigned to the virtual operating element. In addition, there exists an initiation region defined relative to the touch-sensitive position detection apparatus, within which initiation region touch positions are interpreted as selection of the corresponding virtual operating element.

Compressive force measuring apparatus denotes any measuring device which is able to measure an actuation force acting perpendicularly to the touch surface in the event of the actuation of the touch surface of a position detection apparatus. All sensor types and sensors or sensor elements which enable such a measurement are appropriate here.

Strain gages denote strip-shaped sensor elements which change a physically measurable property on account of a strain of the strip. In particular, strain gages are embodied as resistive sensor elements that change their resistance in the event of a strain.

Controller of an apparatus denotes a totality of all components which are provided for evaluating detected signals or user inputs and/or for controlling parts of the apparatus and/or other apparatuses. The components of the controller can be implemented in hardware and/or software or combinations of hardware and software. Components of the controller which are embodied in the operating unit of the operating apparatus are referred to as local control devices.

For purposes of the present disclosure, the term haptic feedback describes an effect that can be perceived by the human sense of touch for the purpose of feedback to a user of an apparatus.

Insofar as mention is made here of detecting or determining the press-on force, this is taken to mean detecting or determining that is embodied separately from the touch-sensitive position detection. This is carried out by means of at least one compressive force measuring apparatus embodied in addition to the touch-sensitive position detection apparatus.

One disclosed operating apparatus, in particular for a motor vehicle, comprises a housing, a touchscreen, which has a display apparatus having a freely programmable display surface for representing at least one virtual operating element and a touch-sensitive position detection apparatus having a touch surface arranged in front of the display surface, wherein at least the touch surface is mounted on the housing movably relative thereto; at least one compressive force measuring apparatus for determining a press-on force acting on the touch surface in the event of a touching actuation of the touchscreen; at least one actuator device coupled directly or indirectly to the touch surface and serving for the targeted movement of at least the touch surface relative to the housing; and a controller designed to determine, depending on the detected touch positions and detected press-on forces, whether a correct haptic actuation of the at least one virtual operating element is present, and, if this is the case, to initiate a function assigned to the at least one virtual operating element and to drive the at least one actuator device to generate a haptic feedback at the touch surface, wherein the controller is designed to compare the press-on forces with a first force threshold value and a second force threshold value deviating therefrom and to generate a first actuator activation signal in the event of the first force threshold value being exceeded, and to generate a second actuator activation signal, which is different from the first actuator activation signal, in the event of the second force threshold value subsequently being undershot, wherein the first and second actuator activation signals are configured to instigate in each case a coupling-in of a short mechanical pulse at the touch surface via the actuator device, and wherein the haptically perceptible feedbacks generated by the first actuator activation signal and the second actuator activation signal at the touch surface are different. This means that different haptic perceptions are brought about for a user. What is important here is that the haptic feedbacks brought about by the two actuator activation signals initiate independent pulselike haptic feedbacks.

A method for operating functions is provided, comprising the following steps: representing a virtual operating element on a display surface, detecting touch positions on a touch surface of a touch-sensitive position detection apparatus, the touch surface being coupled to the display surface, detecting press-on forces in the event of a touching actuation of the touch surface; evaluating the detected touch positions and press-on forces and determining whether a correct haptic actuation of the virtual operating element is present, and, if this is the case, initiating a function assigned to the at least one virtual operating element, and generating a haptic feedback at the touch surface, wherein the press-on forces determined are compared with a first force threshold value and a second force threshold value and a first haptic feedback is generated at the touch surface in the event of the first force threshold value being exceeded, and a second haptic feedback, which deviates from the first haptic feedback, is subsequently generated at the touch surface in the event of the second force threshold value being undershot, wherein the first haptic feedback and the second haptic feedback are embodied as pulselike deflections of the touch surface. It goes without saying that the second haptic feedback is generated only if the first haptic feedback is generated beforehand.

Optionally, the haptic feedback is generated only if the at least one function is selected. This means that the haptic feedback is generated only if the detected touch position lies in the initiation region of a virtual operating element. An evaluation of the detected press-on forces relative to the force threshold values can be omitted if no function is selected as function to be initiated. If a function is selected as function to be initiated, the first haptic feedback is initiated upon the first force threshold being exceeded and the second haptic feedback is initiated upon the second force threshold subsequently being undershot. Therefore, the controller is designed to select the at least one function as function to be initiated if the detected touch position lies in an initiation region of the at least one virtual operating element that is assigned to the at least one virtual operating element. For the developed method it is provided that during evaluation the function assigned to the at least one virtual operating element is selected as function to be initiated if the detected touch position is situated in an initiation region assigned to the virtual operating element.

Disclosed embodiments also provide an acoustic feedback besides the haptic feedback. For this purpose, at least one disclosed embodiment comprises a loudspeaker arranged on or in the housing and the controller has a sound generating device, which outputs an acoustic sound via the loudspeaker in a manner temporally synchronized at least with one of the actuator activation signals. Optionally, an acoustic sound is in each case output via the loudspeaker both with the first haptic feedback and with the second haptic feedback. In at least one disclosed embodiment, a sound signal is in each case output in a temporally synchronized manner both with the first haptic feedback and with the second haptic feedback. The two sounds that are output may be configured differently for the two haptic feedbacks.

Since a human user is able to spatially locate sound sources, it is necessary, for an optimum simulation of a mechanical button by a touch-sensitive position detection apparatus coupled to a display surface, to emit the sound spatially near the touch surface at which the mechanical actuation is performed. Therefore, the loudspeaker may be arranged in or on the housing on which the touch surface of the touch-sensitive position detection apparatus is mounted.

To ensure a temporal synchronism with regard to detecting the haptic feedback at the touch surface and detecting the acoustic sound, the operating apparatus may comprise a delay device, which temporally delays an electronic sound activation signal relative to the actuator activation signal such that the time required for the mechanical deflection of the touch surface is compensated for by the relative delay of the electronic sound activation signal in relation to the actuator activation signals, such that a maximum deflection of the pulselike mechanical deflection is output simultaneously with the beginning of an acoustic sound, optionally a sound pulse. The sound activation signal brings about the outputting of the acoustic sound or sound signal by means of the sound generator.

The temporal synchronization improves the sound assignment to the haptic feedback.

In at least one disclosed embodiment, the actuator device is designed to deflect the touch surface in a pulselike manner perpendicularly to its areal extent. The haptic feedback can act counter to the actuation direction. As a result, by way of example, the feedback can act in a manner similar to a restoring force of a mechanical operating element.

Optionally, the touch surface is embodied such that it is flexurally stiff. This means that as little flexure or local deformation as possible occurs in the event of an actuation. Such disclosed embodiments, particularly in the case of actuators which bring about a movement perpendicular to the areal extent of the touch surface, have the effect that the actuators have to be able to exert greater forces on the touch surface than in disclosed embodiments in which actuators deflect the touch surface in the plane of the areal extent and thus perpendicular to the actuation direction.

In these disclosed embodiments with feedback deflection in the plane of the touch surface, a “fixed” mounting in the operating direction is possible more easily. Furthermore, an actuator initiation has hardly any influence on the compressive force measurement since only the force perpendicular to the direction of movement of the feedback, namely perpendicular to the touch surface, is measured during the compressive force measurement. However, a lateral movement, if the touch surface is rigidly coupled to the display surface arranged behind it, and the latter is thus concomitantly deflected during the haptic feedback, leads to a disturbance of optical perception of the items of information displayed on the display surface. The items of information are then perceived as moving or unsharp. Therefore, the deflection amplitude should be chosen such that these effects remain as minimal as possible.

The touch surface, if appropriate with the display surface of the display apparatus, may be mounted on the housing by means of leaf springs. To prevent dust and dirt from penetrating into the apparatus, a frame of the housing may overlap an edge region of the touch surface or of the display apparatus coupled to the touch surface.

Strain gages that alter their resistance depending on their strain have proved to be particularly suitable force measuring sensors. An electronic measuring circuit determines the resistance of a strain gage and generates an electronic signal representing the press-on force. In at least one disclosed embodiment, the signal is configured such that a signal strength is proportional to the press-on force determined. In disclosed embodiments using strain gages, a plurality of strain gages are arranged at the plurality of mounting locations of the touch surface with the housing and are evaluated jointly or individually.

In other disclosed embodiments, a plunger, for example, is coupled to the touch surface, the plunger experiencing a deflection in the actuation direction in the event of a touching actuation. A capacitor electrode is deflected by means of the plunger, such that a capacitance of a capacitor changes depending on the press-on force transmitted by the plunger. A force signal is again generated by means of an electronic circuit. Embodiments that evaluate a plurality of such force measuring sensors are conceivable here as well.

Still other disclosed embodiments measure the press-on force inductively. In the case of an inductive force measuring sensor, for example, a pot magnet is rigidly coupled to the touch surface and projects into a coil. In the event of a deflection of the touch surface, the pot magnet is moved along the coil axis and thus brings about induction in the coil. By way of the induced current it is possible to determine the force initiating the movement of the pot magnet. In some disclosed embodiments, the same arrangement used for force measurement can also be used as an actuator by the coil being energized in a targeted manner Disclosed embodiments comprise a plurality of such inductive actuator-sensor devices arranged for example in the four corners of a rectangularly embodied touch surface, at the rear side of the touch surface, or a rear side of the display apparatus arranged behind the latter.

Other disclosed embodiments can provide piezo-sensors for determining the force.

Actuator devices comprising actuators which bring about a deflection parallel to the touch surface may also be electromechanical actuators. The actuator activation signals or driving signals derived therefrom for the actuator or actuators and also the actuators and the mounting of the touch surface may be configured such that the feedback pulses used for the different haptic feedbacks initiate as far as possible only a single deflection and return to the rest position with, if appropriate, a very greatly damped overshoot. Different haptic feedbacks can thus be configured differently by means of an intensity of the deflection but also by means of a duration of the deflection.

In general, a multiplicity of functions are offered simultaneously for operation by means of such an operating apparatus, such that the display apparatus is designed to represent a plurality of virtual operating elements simultaneously. An initiation region is then assigned to each virtual operating element. On the basis of the detected touch position it is possible to determine which virtual operating element the user wishes to actuate with the actuation element and it is possible to select the function assigned to the corresponding virtual operating element. The corresponding function is then initiated in each case only if the first force threshold is exceeded during the actuation.

In some disclosed embodiments, the function initiation is performed as early as when the first force threshold is executed.

Optionally, function initiation may be initiated only when the second force threshold is undershot.

If a multiplicity of different functions can be operated and initiated by means of the operating apparatus, then a complex logic is necessary to implement the of the underlying operating logic of a human-machine interface (HMI). The latter is often implemented in a central computer in a program-controlled manner in interaction with a central processor device in modern motor vehicles. The display apparatus and the touch-sensitive position detection apparatus in each case have a dedicated control device, these being respectively arranged spatially adjacent to the touch surface and the display surface. The control of the operating apparatus can thus be divided between these local control devices and a central computer coupled thereto via a BUS system.

To obtain a haptic feedback near-instantaneously with the actuation, the initiation of the haptic feedback is brought about by means of a haptic control device integrated into the operating unit. In at least one disclosed embodiment, the haptic control device merely evaluates the detected press-on forces. As soon as the first force threshold value is reached or exceeded, the first haptic feedback and, if appropriate, the first acoustic feedback are output as a sound signal output in a temporally synchronized manner. In the event of the second force threshold value subsequently being undershot, the second haptic feedback and, if appropriate, the second acoustic feedback are output.

To prevent the haptic feedback from being generated if the user presses against the touch surface with the actuation element at a location which does not lie in the initiation region of a virtual operating element, a local haptic controller may be designed such that the positions or regions of the touch surface at which an initiation region of one of the virtual operating elements represented on the display surface are communicated to the controller. Monitoring of the force thresholds takes place in a local haptic control device, as does checking of the currently determined touch positions relative to the touch positions of the activation regions. If the touch position lies in any of the activation regions and if, at the same time, the first force threshold is exceeded, then the first actuator activation signal and, if appropriate, additionally the first sound activation signal are generated. Afterward, after the second force threshold has subsequently been undershot, the second actuator activation signal and, if appropriate, a second sound activation signal are generated. This disclosed embodiment provides a haptic feedback that is generated in the event of an operating element activation in each case near-instantaneously and without being influenced by communication times to the central computer and the processing speed thereof. In addition, the touch positions and force values are communicated via a bus system to the central computer, which then instigates the actual function initiation and, if appropriate, graphical reconfiguration of the items of information represented on the display surface.

In other disclosed embodiments, the generation of the actuator activation signals and/or of the sound activation signals can also be generated and initiated exclusively by means of an operating logic implemented in the central computer. This enables a comprehensive logical control.

In addition, at least one disclosed embodiment can provide for the touch positions detected temporally in association additionally to be combined to form touch tracks and for these touch tracks or sections thereof to be classified in relation to predefined touch gestures. If a touch track is classified as a touch gesture, then a function linked to the touch gesture can be initiated. In particular, functions such as magnifying and/or reducing the graphical representation (zooming), scrolling in lists, etc. can thus be realized. By contrast, the individual list entries can be virtual operating elements, the actuation of which initiates the haptic feedback described above.

Alternatively or additionally, in some disclosed embodiments provision can be made for a further haptic feedback to be output in the event of accessing and/or leaving a virtual operating element, in particular in the event of the touch surface being lightly touched. In this regard, finding the actuatable operating elements without devoting gaze attention is possible more easily. In this case, the haptic feedbacks for accessing and leaving a virtual operating element can differ. A user can thus haptically distinguish between both processes. The feedbacks may differ from those which are generated when the virtual operating element is actuated. Accessing a virtual operating element is understood to mean the first detection of a touch position in an initiation region of the operating element after previously detected touch positions, if such were detected at all in a preceding predefined time interval, were not situated in the initiation region. Conversely, leaving is established if the touch position is no longer detected in the initiation region of the virtual operating element in which touch positions of the actuating element were previously detected. In some disclosed embodiments, moreover, first touching of the touch surface in an initiation region is regarded as accessing and ending of the touching previously effected in an initiation region is regarded as leaving. Other disclosed embodiments exclude these two cases.

In particular, a function assigned to a virtual operating element can be a function in a motor vehicle. In this way, some of the functions or all of the functions in a motor vehicle can be controlled interactively. In at least one disclosed embodiment, the assigned function is a function in a motor vehicle. Precisely in the case of a multiplicity of functions which have to be offered and supervised nowadays in modern motor vehicles, despite a limited availability of space in a passenger compartment of the motor vehicle, the possibility is thus afforded of representing all functions, and making them drivable, in an orderly and clear manner and nevertheless not having to dispense with appealing haptics.

In a further disclosed embodiment, provision is made for the operating apparatus to be designed for use in a motor vehicle. The operating apparatus can be arranged for example in a center console of the motor vehicle or alternatively in the rear region of the motor vehicle.

The operating apparatus is suitable for all application possibilities in which a human-machine interaction is necessary or desired. Another disclosed embodiment provides for the operating apparatus to be part of a land vehicle, an aircraft, a watercraft, an automatic vending or information machine, a telephone, a tablet computer, a personal computer, an interactive item of furniture, a television, a domestic appliance, a production or process installation, a control station, a domestic appliance or an appliance appertaining to consumer electronics or a gaming machine. The operating apparatus allows a multiplicity of functions of the apparatus to be represented and made drivable in a clear and ordered manner even in the case of limited space for an arrangement of operating elements for detection of haptic user inputs. In this case, the housing of the operating apparatus can be part of an outer apparatus housing or the apparatus housing of a corresponding apparatus. However, the housing can also be merely connected to the outer apparatus housing of the corresponding apparatus, for example inserted into the apparatus housing.

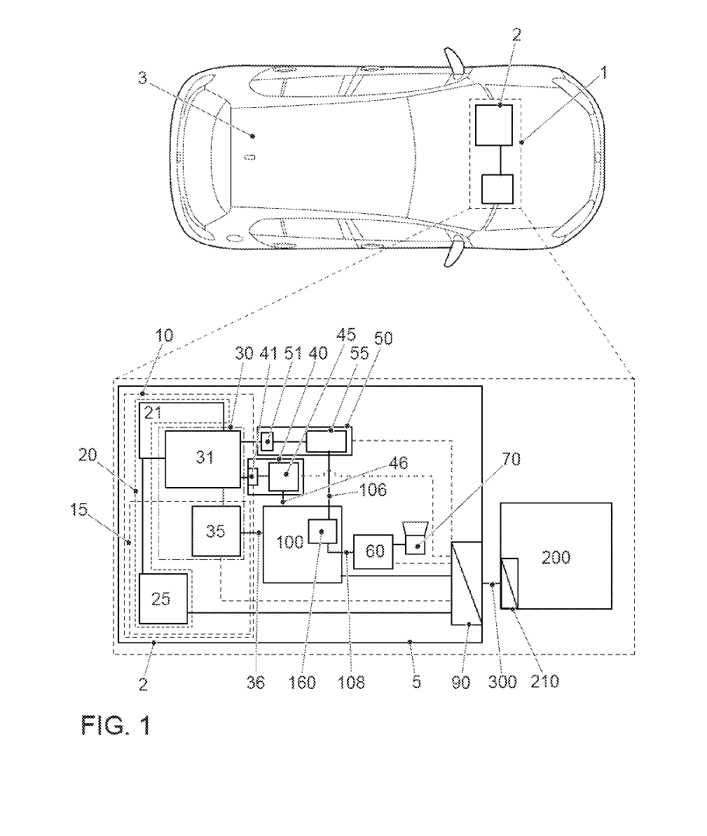

In FIG. 1, a motor vehicle 3 with an operating apparatus 1 is schematically illustrated. The operating apparatus 1 comprises an operating unit 2 having a housing 5, which is generally arranged in the region of the dashboard, optionally in a center console. A touchscreen 10 is arranged in the housing, the touchscreen comprising a freely programmable display apparatus 20 and a touch-sensitive position detection apparatus 30 linked thereto. In most disclosed embodiments, a display surface 21 of the freely programmable display apparatus 20 is fixedly connected to a touch surface 31 of the touch-sensitive position detection apparatus 30. In any case at least the touch surface 31 of the touch-sensitive position detection apparatus 30 is mounted movably relative to the housing 5, optionally elastically.

A display control device 25 controls the representation of information on the display surface 21. A position detection control device 35 is designed such that it determines coordinates for detected touch positions of a touching actuation of the touch surface 31 by an actuation element (not illustrated). The touch surface 31 is transparent and can be integrated into the display surface 21. Consequently, the items of information represented on the display surface 21, for example graphical characters, pictograms, graphical representations of operating elements and the like, are visible through the touch surface 31.

A compressive force measuring apparatus 40 is coupled to the touch surface 31 or, if the touch surface is fixedly connected to the freely programmable display apparatus 10, to the touchscreen 10, and is able, in the event of a touching actuation, to measure an actuation force acting on the touch surface 31 perpendicular to the latter. By way of example, one or a plurality of sensor elements 41 can be connected to the touch surface 31, the sensor elements, in the event of a deflection of the touch surface 31, generating a signal that is converted by a pressure measuring control device 45 into a compressive force signal 46 indicating the press-on force or actuation force determined. Furthermore, at least one actuator device 50 comprising an actuator 51 controlled by an actuator control device 55 is coupled to the touch surface 31 or, if the touch surface 31 is fixedly connected to the display surface 21, to the touchscreen 10.

The operating apparatus 1 comprises a haptic control device 100, which is arranged in the housing 5 and which is connected at least to the pressure measuring control device 45, i.e. the compressive force measuring apparatus 40, and the actuator control device 55, i.e. to the actuator device 50. The haptic control device 100 is designed to generate actuator activation signals 106 on the basis of the detected press-on forces, the actuator activation signals then being converted by the actuator controller 55 such that the actuator 51 deflects the touch surface 31 of the touch-sensitive position detection apparatus 30, such that a haptically perceptible effect arises.

In at least one disclosed embodiment, the haptic control device 100 checks the detected press-on force or actuation force relative to a first force threshold or a first force threshold value. If the force threshold or the first force threshold value is reached or exceeded, then a first actuator activation signal 106 is generated, which brings about a first haptic feedback via the actuator control device 55 and the actuator 51 at the touch surface 31. If subsequently, after the first force threshold or the first force threshold value was reached or exceeded once by the detected press-on or actuation force, a second force threshold or a second force threshold value, which is lower than the first force threshold value, is undershot, a second actuator activation signal 106 is generated, which brings about a second haptic detectable effect at the touch surface 51 via the actuator control device 55 and the actuator 51. Optionally, the two detectable haptic effects are different, such that a user can differentiate between them. Optionally, the haptic effects are embodied as short, as far as possible single deflections of the touch surface. These may differ with regard to the deflection amplitude, wherein the deflection amplitude may be greater in the case of the haptic effect generated by the first actuator activation signal than in the case of the haptic effect initiated by the second actuator activation signal.

To improve the sensory perception by a user, in particular to be able to better simulate button operating elements by means of the touchscreen 10, the haptic controller 100 may also output in each case a sound activation signal 108 to a sound generator 60, which, via a loudspeaker 70 arranged on or in the housing, outputs a sound signal or a sound in a manner synchronized with the deflection of the touch surface 31 that is brought about via the actuator 51. In this case, a delay device 160 may be provided in the haptic control device 100, the delay device delaying the corresponding actuator activation signal 106 and the sound activation signal 108 relative to one another such that a maximum deflection of the touch surface 31 is effected simultaneously with the outputting of the sound signal. The outputting of the sound signal in a manner temporally synchronized with the haptic feedbacks better simulates a sensory perception of button operation that is familiar to the user. In this case, the arrangement of the loudspeaker 70 on or in the housing 5 ensures that the user, on the basis of his/her spatial hearing ability, correlates the output acoustic sound signal with the haptic effect since the signal is perceived as coming from the touching location. The feedback effect is strengthened. It has been found that the feedback which is supported by an acoustic sound signal output locally adjacently to the touch surface is perceived as intensive feedback. It has likewise emerged that a haptic feedback with a reduced mechanical deflection which is supplemented by a sound signal output in a locally synchronized manner is perceived just as intensively as a feedback with increased mechanized deflection without sound support. Consequently, a weaker actuator can be used if synchronized, locally output sound support is used. This furthermore minimizes wear owing to reduced deflection of the touch surface in conjunction with a feedback effect perceived almost just as intensively by a user.

Such at least one disclosed embodiment provides a haptic feedback is output in the event of a touching actuation at any position, independently of whether an initiation region of a virtual operating element is assigned to the position on the display surface via a human-machine user interface.

In a further disclosed embodiment, the haptic control device 100 may likewise be coupled to the position detection control device 35, such that the haptic control device 100 additionally checks whether the detected touch position lies in an initiation region of a virtual operating element. If this is the case, the actuator activation signals 106 and, if appropriate, the sound activation signals 108 are output in the event of the first force threshold or the first force threshold value being exceeded and in the event of the second force threshold or the second force threshold value subsequently being undershot. In addition, the haptic control device 100 can be designed such that it determines, on the basis of the detected touch position, the initiation region in which the touch position is detected while the first force threshold is exceeded, and thereby determine an operating function assigned to the corresponding initiation region. It is thus possible for the haptic control device 100 to generate a signal for function initiation and to output it via an interface 90, for example.

Often the human-machine interface logic is not implemented completely in the haptic control device 100 of the operating unit, but rather is implemented at least partly in a central computer 200, which is connected to the interface 90 of the operating unit 2 via a central computer interface 210 and a bus 300. In at least disclosed embodiment, the central computer 200 communicates at least information about the activation regions of the individual virtual operating elements for which the two different haptic feedback effects are intended to be output in the event of a touching actuation with the sufficient press-on force, as explained above. Consequently, independently of a duration of transmission of information to the central computer, and the processing time thereof, the haptic controller is able to generate the haptic feedbacks near-instantaneously if the detected touch position is identified within one of the initiation regions while the first force threshold is exceeded and the second force threshold is undershot.

However, embodiments are also possible in which the entire or almost the entire functionality of the haptic control device 100, as described previously, is implemented in the central computer 200. The determined press-on force values and detected touch positions are then communicated to the central computer. The central computer 200 then evaluates the touch position to the effect of determining whether the latter lies in an initiation region of one of the virtual operating elements, the virtual operating elements being respectively linked to a function to be operated. A function to be initiated is thus selected by means of this evaluation. If such a selection is successful, the communicated press-on force values are additionally evaluated and compared with a first force threshold, i.e. a first force threshold value. If the latter is reached or exceeded, the first actuator activation signal is transmitted by the central computer via the bus 300 to the haptic control device 100 or directly to the actuator control device 55. Analogously, in addition a sound activation signal can be communicated either via the haptic control device 100 or directly to the sound generator 60. Optionally, only activation information is communicated and the concrete drive signals are generated in the actuator control device 55 and the sound signals output to the loudspeakers 70 are generated in the sound generator 60.

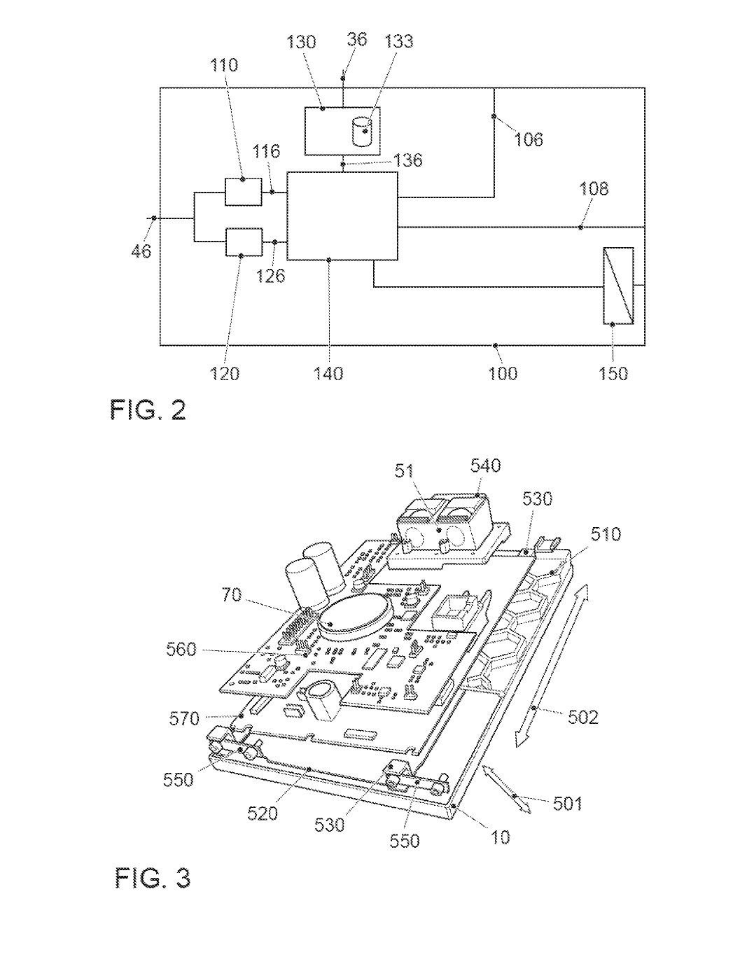

FIG. 2 schematically illustrates at least one disclosed embodiment of a haptic control device 100. The latter comprises two comparators 110, 120, which compare a signal representing the press-on force with a first force threshold and a second force threshold. Furthermore, a further comparator 130 is provided, which evaluates a position signal 36 of the detected touch positions to the effect of whether it lies in one of the initiation regions of one of the virtual operating elements. Information about the initiation regions that is required for this purpose is stored in a memory 133, for example. Comparison result signals 116, 126, 136 are processed by a haptic logic device 140, which generates the actuator activation signals 106 and/or corresponding sound activation signals 108. The individual detected signals, i.e. a position signal 36, a compressive force signal 46 and the actuator activation signals 106 and, if appropriate, the sound activation signals 108, are additionally output via an interface 150. Information about the initiation regions stored in the memory 133 can also be communicated to the haptic control device 100 via the interface 150.

FIG. 3 schematically illustrates a rear view of a plurality of components of an operating unit 2. A touchscreen 10 can be discerned, the display surface and touch surface of which face away from the observer. The actuation and deflection direction for the pressing actuation is indicated by means of an arrow 501. The touchscreen 10 is arranged on a holder plate 510, which has a honeycomb pattern for stabilization. The holder plate 510 is embodied such that it is as stiff as possible. The holder plate 510 is only partly illustrated. A touchscreen carrier 520 having mounting elements 530 at four corners is arranged between the holder plate 510 and the touchscreen 10. The mounting elements 530 and/or the touchscreen carrier 520 are embodied such that the touchscreen can be deflected elastically in the actuation direction. Furthermore, leaf springs 550 are fitted to the mounting elements 530 and enable movable mounting on a housing (not illustrated), such that a deflection in the plane of the touchscreen 10 is possible by means of an actuator 51, as is indicated by means of an actuator system deflection arrow 502. FIG. 3 furthermore schematically illustrates printed circuit boards 560, 570, in which the various local control devices such as, for example, the display control device, the pressure measuring control device, the haptic control device, the actuator control device and a sound generator are formed. Furthermore, a loudspeaker 70 and an actuator 51 can be discerned, which is fixed firstly to the housing (not illustrated) and secondly to an L-profile 540 of the touchscreen carrier 520.

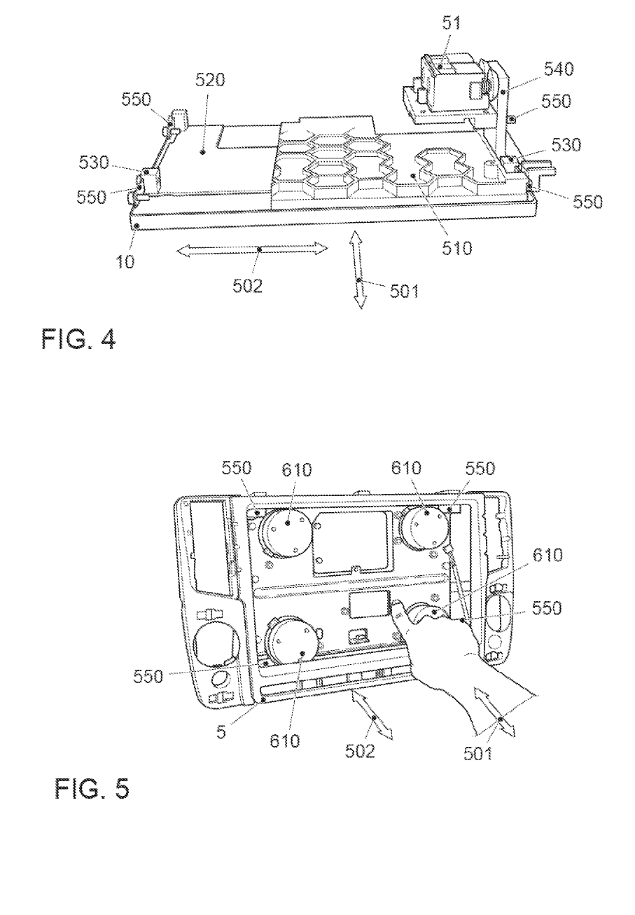

FIG. 4 shows a further schematic view similar to that in FIG. 3, with the printed circuit boards 560 and 570 being absent therein. The L-profile 540 can readily be discerned.

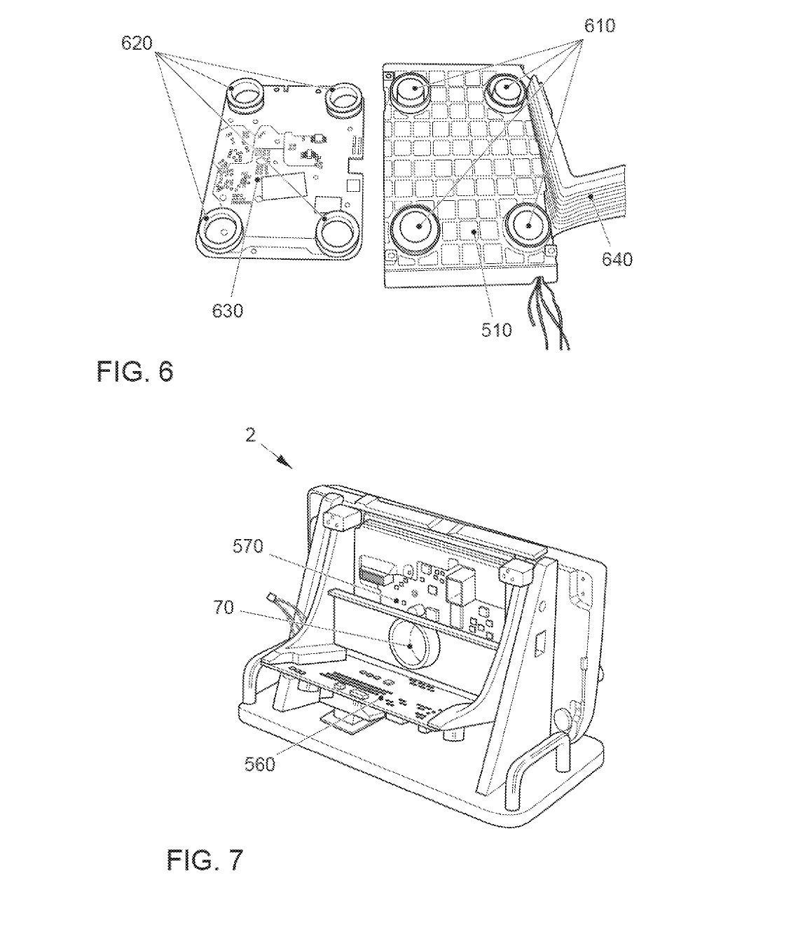

FIGS. 5 and 6 show an alternative configuration of an operating unit. A front view of the housing 5 can be discerned in FIG. 5, the touchscreen, the local control devices and actuators being arranged in the housing. The touchscreen and the holding plate and a touchscreen carrier are not illustrated and are absent in FIG. 5 for reasons of clarification. Furthermore, a covering frame of the housing 5, which covering frame generally covers an edge of the touchscreen to prevent ingress of dust and other dirt constituents, is not shown. The leaf springs 550, to which the holder plate of the touchscreen is fixed, can be discerned. The holder plate is furthermore connected to pot magnets 610 arranged on an underside of the holding plate (cf. FIG. 6). These engage in coils 620 arranged on an electronics circuit board 630. By means of an energization of the coils, the pot magnets can be deflected in the direction of a coil axis 621, i.e. perpendicular to the electronics circuit board or the holder plate 510, to bring about a haptic feedback at the touchscreen arranged on the non-illustrated side of the holding plate 510, the terminals 640 of which touchscreen can be discerned in FIG. 6. The pot magnets 610 together with the coils 620 form actuators. An actuation force acting on the touchscreen can also be measured by means of the actuators, which simultaneously serve as force measuring sensors. In the event of a deflection of the pot magnets 610 in the coils 620, they induce in the coils 620 a current that can be evaluated to determine the press-on force that led to an acceleration of the touchscreen and, via the latter, of the holder plate and of the pot magnet.

FIG. 7 shows a rear view of an assembled operating unit 2. The loudspeaker 70, housing constituents 6 and printed circuit boards 560, 570, in which control devices are implemented, as described above, can be discerned.

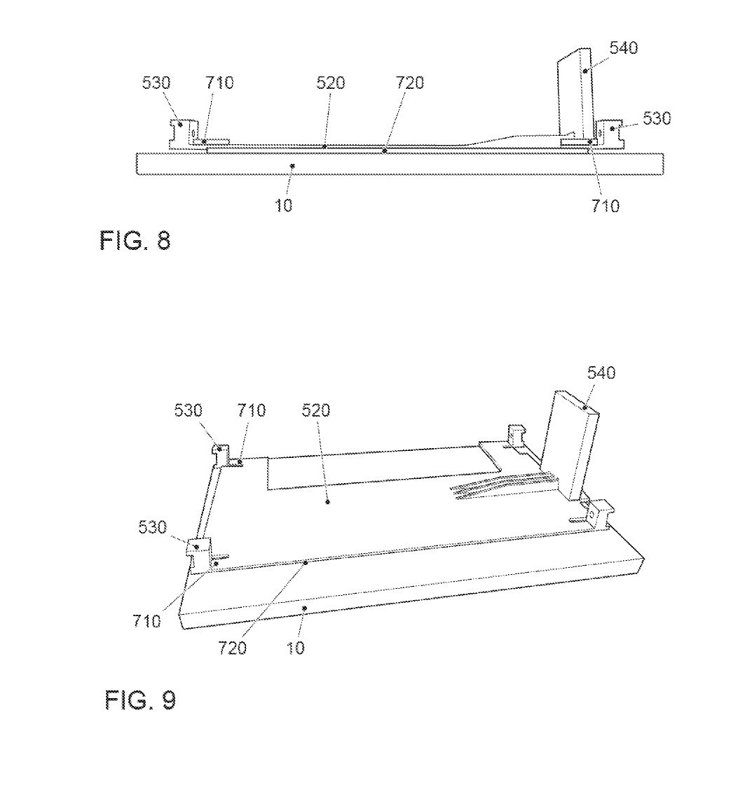

FIG. 8 shows by way of example a schematic side view of a touchscreen 10 arranged on a touchscreen carrier 520 with an L-profile 540. The touchscreen 10 is connected to the touchscreen carrier 520 by means of an adhesive layer 720, for example. Strain gages 710 are arranged in a manner adjoining the mounting elements 530, the strain gages altering their properties, in particular their electrical properties, in the event of a deformation of the touchscreen carrier 520 in the region of the mounting elements and/or a deformation of the mounting elements 530 on account of an actuation force acting on the touchscreen. This change in the electronic properties, for example in the resistance, is converted into a compressive force signal by means of the pressure measuring control device (not illustrated). The compressive force signal indicates the strength of the detected press-on force. The pressure measuring control device is furthermore able to convert the changes detected at the various strain gages 710 into one compressive force signal.

FIG. 9 shows a perspective view of the touchscreen 10, which is fixed to the touchscreen carrier 520, for example by means of an adhesive layer 720.

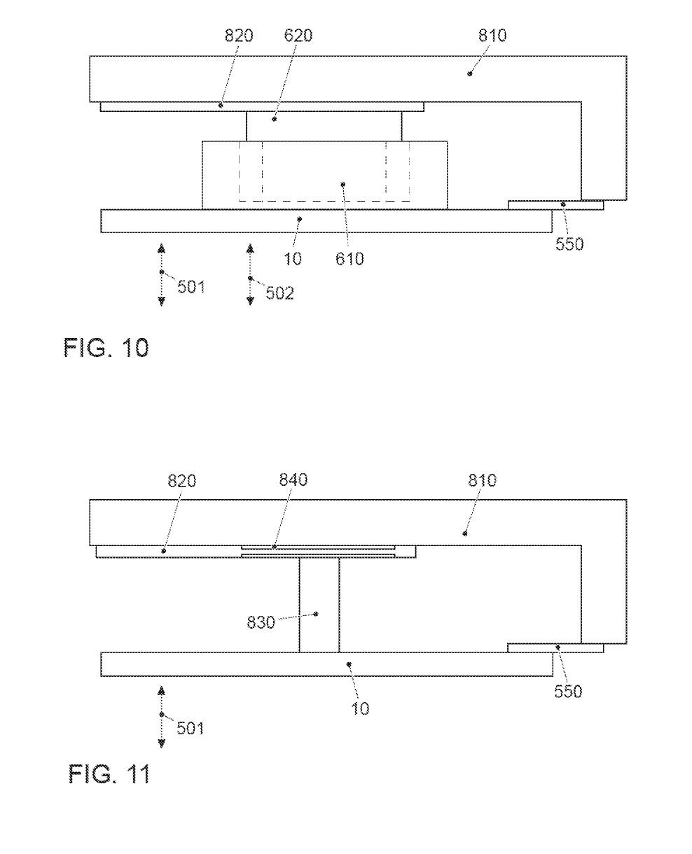

The compressive force detection by means of an inductive actuator system is schematically illustrated again in FIG. 10. The touchscreen 10 can be discerned, which is mounted elastically and movably on a holding frame 810 of the housing 5 by means of leaf springs 550. A pot magnet 610 is fixedly connected to the touchscreen 10 and engages in a coil 620 connected to an actuator control device on a printed circuit board 820, which simultaneously comprises the pressure measuring control device. The printed circuit board 820 is fixedly connected to the holding frame 810, such that the coil is supported against the holding frame 810 and thus the housing and can bring about a deflection of the touchscreen relative to the housing in the actuation direction, indicated by means of the actuation direction arrow 501. The actuator deflection takes place parallel thereto, as indicated by the actuator deflection arrow 502.

FIG. 11 schematically illustrates a further possibility for detecting the actuation force. Once again the touchscreen 10 is mounted, by means of a leaf spring 550, on a holding frame 810 elastically for a deflection in the actuation direction, indicated by means of the actuation direction arrow 501. A plunger 830 is fixedly connected to the touchscreen 10 or the holding plate or touchscreen carrier thereof (neither is illustrated). The acts mechanically on a plate capacitor 840 formed in a printed circuit board 820 supported on the holding frame 810. If the touchscreen 10 is pressed into the housing 5 during an actuation, then the plunger presses onto the plate capacitor 840 and thus alters a plate spacing, which in turn changes a capacitance of the plate capacitor 840. The compressive force that is acting can be derived from this change in capacitance, which, in the case of a charged capacitor, is accompanied for example by a change in voltage between the capacitor plates.

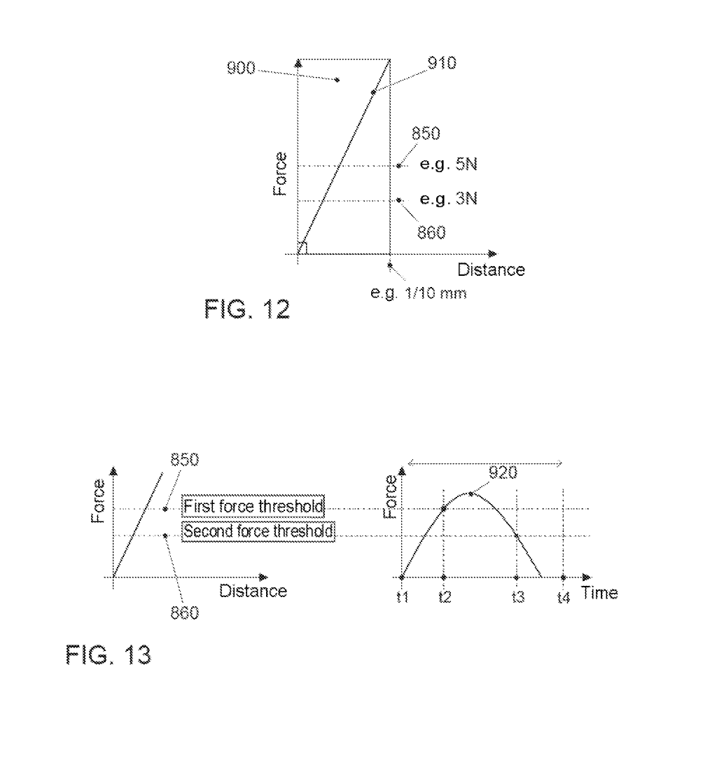

The touch surface of the touch-sensitive position detection apparatus, which may be integrated in a touchscreen, may be mounted in the housing such that an elastic deflection is effected in the actuation direction such that there is a linear relationship between the deflection and the force required therefor. This is plotted graphically in FIG. 12. The working range 900 of the force measuring device is shown. The required force is plotted as a function of the deflection brought about thereby. A gradient 910 indicates a stiffness of the force measurement. In some disclosed embodiments, the deflection is as minimal as possible, for example less than one tenth of a millimeter. Furthermore, two force threshold values 850, 860 are depicted in FIG. 12. A first force threshold value 850, which is assigned to a higher press-on or actuation force, must first actually be reached or exceeded in the event of an actuation of a virtual operating element that the function linked to the virtual operating element can be initiated at all. A first haptic feedback is generated in the event of the first force threshold or the first force threshold value 850 being reached or exceeded. A second haptic feedback is initiated in the event of the second force threshold or the second force threshold value 860 being undershot, which is assigned to a lower force than the first force threshold value 850. The first haptic feedback and the second haptic feedback differ. Optionally, an effected maximum deflection of the touch surfaces of the touch-sensitive position detection apparatus in the case of the feedback associated with reaching or exceeding the first force threshold is greater than the maximum deflection associated with undershooting the second force threshold. This corresponds to the haptic behavior of a physically embodied button. What is important is that, in the event of the second force threshold value 860 being undershot, a haptic feedback is brought about only if the first force threshold value 850 is reached or exceeded beforehand.

FIG. 13 illustrates graphically again the press-on force during an actuation process alongside the graphical illustration of the relationship between deflection and required press-on force. The typical press-on force is plotted against time as press-on force curve 920 during an actuation process that leads to the initiation of a function linked to a virtual operating element. At the instant t1, the user places his/her actuation element, for example his/her finger, onto the touch-sensitive position detection apparatus at a position lying in the initiation region of the corresponding virtual operating element. This may be a position lying in the region of the graphical representation of the virtual operating element. The user then increases his/her press-on pressure until, at the instant t2, the user exceeds the first force threshold value 850 with the actuation force. At this instant, a first actuator activation signal is generated and a pulselike deflection is thereby generated as first haptic feedback at the touch surface by means of an actuator. The user thereby registers that he/she has successfully actuated the virtual operating element, and reduces the press-on pressure. In the event of the second force threshold or the second force threshold value 860 being undershot at the instant t3, a second actuator activation signal is generated and a second pulselike feedback, optionally a further pulselike deflection of the touch surface, the second pulselike feedback being different from the first pulselike haptic feedback, is thereby brought about. This conveys to the user a haptic feedback such as is known to the user from a physically embodied operating element; at the instant t4, the user lifts his/her finger away from the touch surface again.

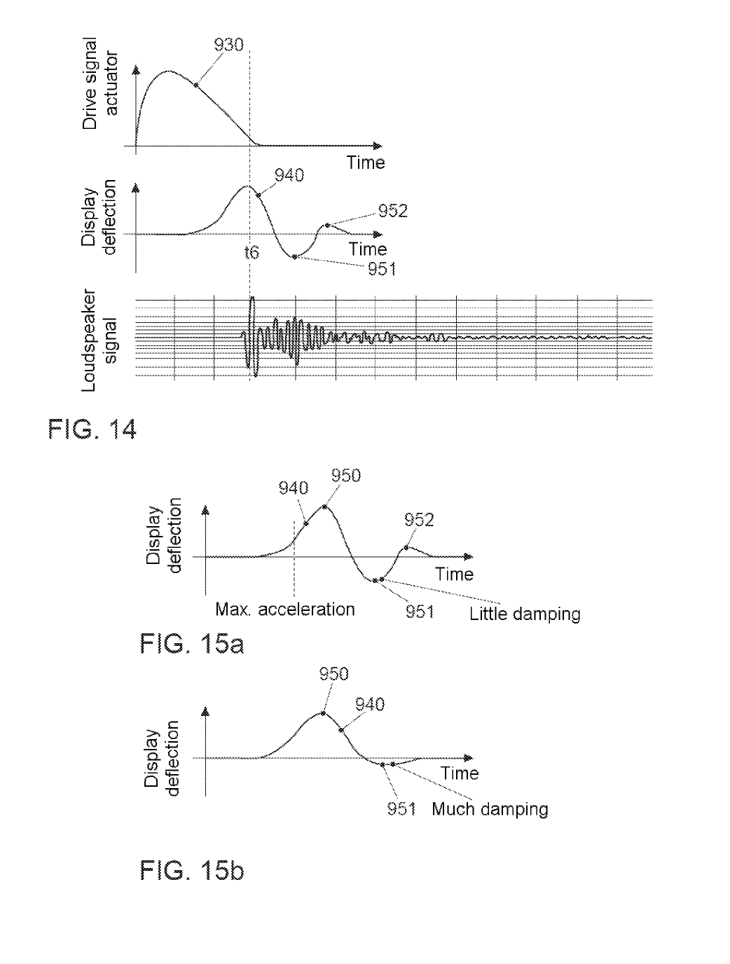

In FIG. 14, the driving signal 930 and the deflection resulting therefrom are schematically plotted graphically in each case against time. In the upper graph, the drive signal 930, such as is communicated from the actuator control device to the actuator, is plotted against time. It can be discerned that a short excitation pulse is generated. The middle graph illustrates the display deflection, i.e. the deflection of the touch surface, against time. It can be discerned that the touch surface deflection reaches a maximum value 955 of a pulselike deflection 950 at an instant t6 at which the driving signal 930 has already almost reached the zero value again. Depending on the damping of the touch surface or of the touchscreen, one or two so-called post-oscillations or overshoots arise. A third graph illustrates the loudspeaker signal 960 that is output, which represents a short sound pulse. The loudspeaker signal 960 is generated with a time delay relative to the driving signal 930 of the actuator, such that a maximum deflection of the acoustic signal coincides with the maximum deflection of the touch surface.

FIGS. 15a and 15b show exemplary deflections of the touch surface against time for the same excitation signal as illustrated in FIG. 14. While the mounting of the touch surface is only weakly damped in the disclosed embodiment corresponding to the graph according to FIG. 15a, such that the overshoots 951, 952 already described above occur, only a weakly manifested overshoot 951 is to be observed, by contrast, alongside the desired pulselike deflection 950 in the case of greater damping (see FIG. 15b). The deflection behavior shown in FIG. 15b corresponds to an optional deflection behavior.

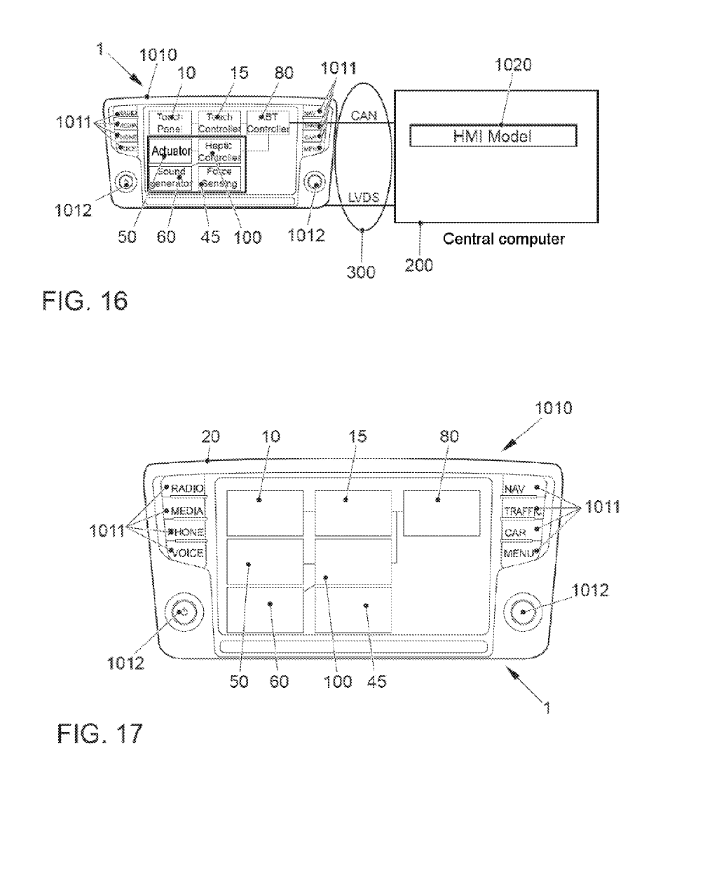

FIG. 16 schematically shows the operating apparatus 1 with the various control devices which enable a function initiation for virtual operating elements with the inventive haptic feedback. The operating apparatus 1 comprises the operating unit having the housing 5, in which further physically embodied operating elements 1010 are pushbuttons 1011 and rotary encoders 1012 are formed alongside the touchscreen 10. In the housing 5, firstly, a local operating unit control device 80 is integrated, which handles for example communication with a central computer 200 via one or a plurality of buses 300. By way of example, the control signals, that is to say actuator activation signals, sound activation signals, force threshold initiation signals, force values, etc., can be transmitted via a serial bus, e.g. a CAN bus. In this case, CAN stands for controller area network. Graphical information may be transmitted via an LVDS bus. In this case, LVDS stands for low voltage differential signaling. Furthermore, the operating unit control device 80 is responsible for the processing of signals of the physically embodied operating elements 1010. In addition, a touchscreen 10 and a touchscreen control device 15, which comprises the display control device and the position detection control device (cf. FIG. 1), are present on or in the housing 5. In addition, a haptic control device 100 is present, which is coupled to the pressure measuring control device 45. Furthermore, the actuator device 50 and a sound generator 60 are coupled to the haptic control device 100 and are correspondingly driven via the haptic control device 100 as described above for generating a haptic and acoustic feedback. The haptic controller can be completely implemented in the control devices locally integrated into the housing. Alternatively, however, part of the haptic feedback can be controlled and influenced via a human-machine interface implemented in a human-machine model 1020 on the central computer.

FIG. 17 shows a disclosed embodiment, similar to that according to FIG. 16, in which the central computer is absent and the entire haptic controller is realized in the local control devices in the housing 5 of the operating unit 2, in which the touchscreen is mounted.

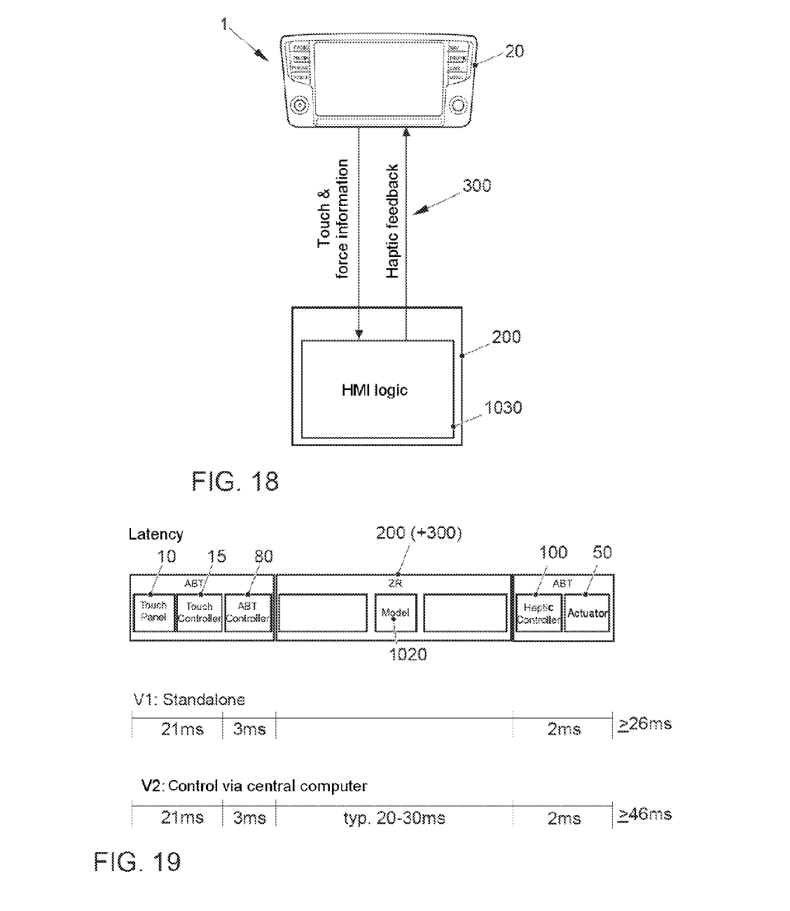

FIG. 18 schematically illustrates at least one disclosed embodiment in which the entire logic for the haptic feedback is embodied in the central computer 200. Via the bus 300, for example a CAN bus, touch and force information is transmitted and evaluated in the human-machine interface logic on the central computer, which transmits signals for controlling the haptic feedback back to the local control devices in the housing around the touchscreen.

FIG. 19 illustrates the latencies below the individual schematically indicated control devices of the controller. In the variant in which the haptic feedback is realized without the central computer, only the processing times caused by the touchscreen 10 and the touchscreen control device 15 thereof and the operating unit control device 80 occur. In addition, the times required by the haptic controller 100 and the actuator device 50 to generate the haptic feedback signal occur.

In a further disclosed embodiment in which the logic is implemented in the central computer 200, further latencies additionally occur, which are required for the bus transmission and the evaluation of the logic in the central computer. The indicated latencies for the individual components correspond to at least one disclosed embodiment. An acceptable total latency that is not perceived as time delayed by a user should not exceed 50 milliseconds reaction time between the event of the force threshold being exceeded and the haptic feedback.

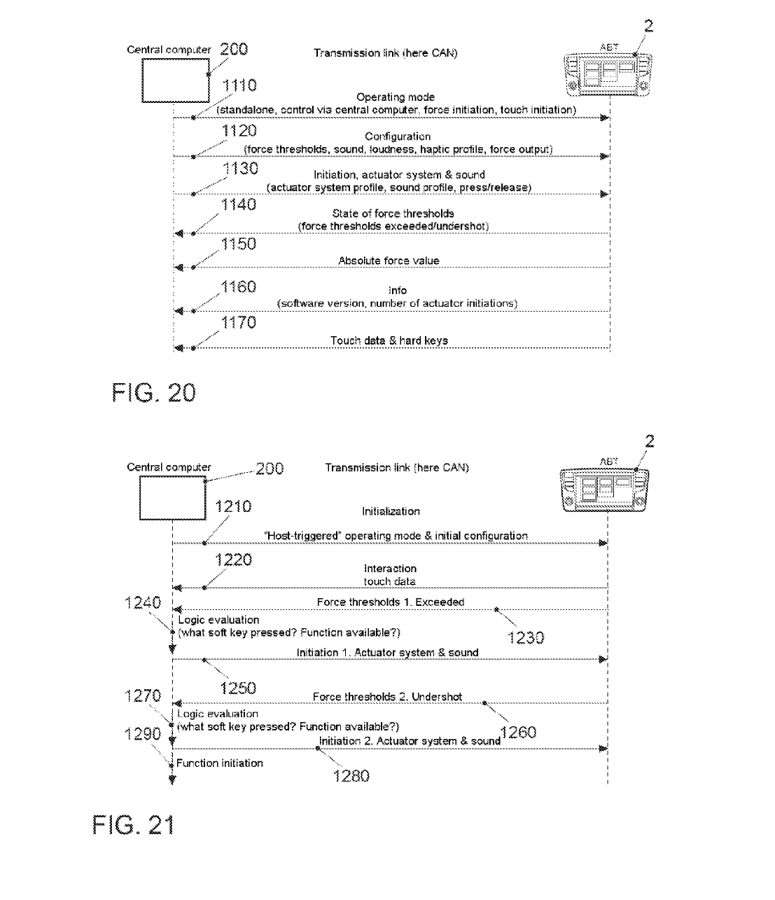

FIG. 20 illustrates the interface for the communication between the central computer and the operating unit 2 embodied locally with the touchscreen 10. The transmission link can be a CAN bus, for example. The operating mode 1110 of the local operating unit is controlled by the central computer. It is thereby possible to stipulate that the haptic controller is intended to be constructed with recourse to the central computer. It can likewise be stipulated that virtual operating elements are intended to be activated and initiated only in the event of a sufficient actuation force or already in the event of simple touching. Furthermore, the local operating unit is configured 1120 via the interface, e.g. the force thresholds are defined, the sounds are defined, the loudness of the acoustic signals but also an excitation profile 1130, etc. By contrast, the local control devices of the operating unit 2 communicate force threshold exceedances 1140 and absolute force values 1150 to the central computer. Furthermore information 1160 about the local control devices present and their version number and also touch positions and signals 1170 which are associated with the actuation of physically embodied operating elements.

With reference to FIG. 21, an explanation will be given of the sequence of the transmitted messages in the case of an operating process for a disclosed embodiment with an operating logic embodied on the central computer. Firstly, an initialization message packet 1210 is transmitted from the central computer to the local operating unit, which configures the local operating unit. If touching takes place, the touch position data 1220 are communicated to the central computer. If an exceedance or reaching of the first force threshold is subsequently detected, then the exceedance of the first force threshold is also communicated 1230 to the central computers. The latter carries out a logic evaluation 1240 and generates a signal for initiating a first haptic and acoustic feedback 1250. If the second force threshold is undershot, then this is again communicated 1260 to the central computer, which, after a further logic evaluation 1270, transmits 1280 signals for initiating the second haptic effect and the second sound signal to a local operating unit. Furthermore, the central computer instigates the initiation of function 1290 associated with the actuated virtual operating element.

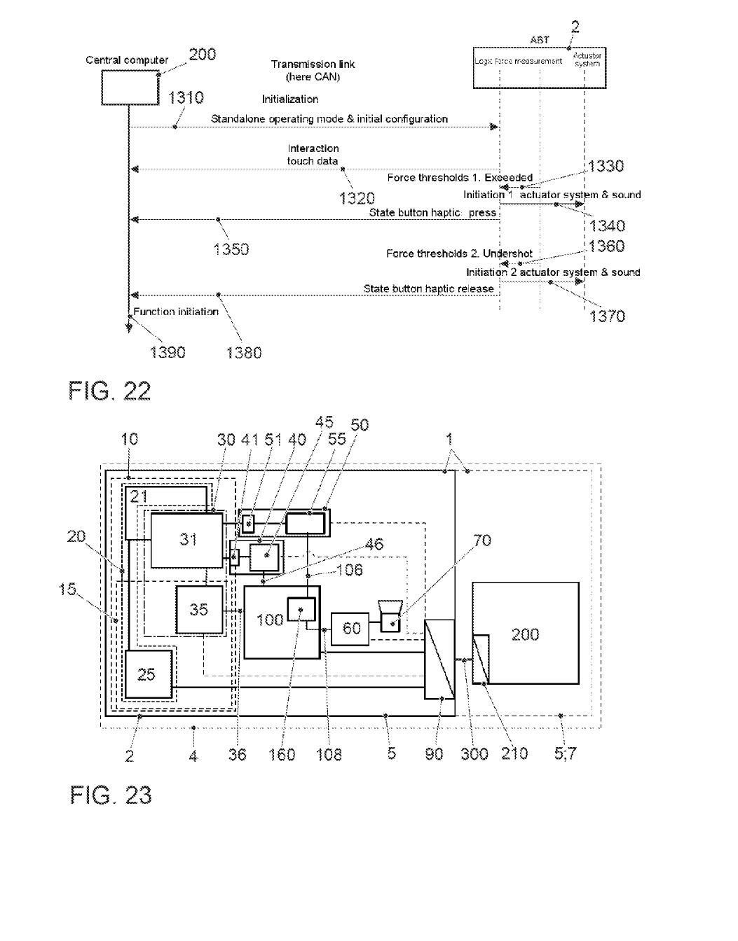

FIG. 22 shows the message telegram for at least one disclosed embodiment in which the haptic initiation is implemented locally in the local operating unit 2. An initialization 1310 by means of which the local operating unit is configured again takes place via the central computer 200. Touch positions determined are again communicated 1320 to the central computer in the event of a detected actuation. If it is determined by means of the compressive force measurement that the first force threshold is exceeded 1330, then a first haptic and acoustic feedback is initiated 1340 by the haptic control device in the local operating apparatus. The fact that the virtual operating element is completely depressed is communicated 1350 to the central computer. Once the user releases the virtual operating element again, the second force threshold is undershot. As soon as this is identified 1360, the local haptic control device outputs 1370 a second haptic feedback via an actuator activation signal and a sound activation signal. The fact that the user has released the button again is communicated 1380 to the central computer. The central computer thereupon instigates a function initiation 1390.

FIG. 23 schematically illustrates an apparatus 4 comprising an operating apparatus 1. The operating apparatus 1 is embodied analogously to that according to FIG. 1. The apparatus 4 is a technical device comprising an interactive human-machine interface for detecting haptic inputs. The apparatus 4 can be, for example, a land vehicle, an aircraft, a watercraft, an automatic vending or information machine, a telephone, in particular a smartphone or other cellular phone, a tablet computer, a personal digital assistant (PDA), a personal computer, an interactive item of furniture, a television, a domestic appliance, a production or process installation, a control station, a domestic appliance or an appliance appertaining to consumer electronics or a gaming machine, a games console or the like. An interactive item of furniture is considered to be items of furniture which are adaptable by means of actuators, for example, such as a bed or an armchair, and also items of information which enable communication of information, such as a table having a table top embodied wholly or partly as a screen, or a wall panel having a screen, etc.

In some disclosed embodiments, the housing 5 is arranged and may be fixed on or in the apparatus 4 in a manner similar to that in FIG. 1. For this purpose, the housing 5 can have fixing element. These are used to fix the housing 5 of the operating apparatus 1 in an apparatus housing 7 of the apparatus 4 or on the apparatus housing 7 of the apparatus 4.

In other disclosed embodiments, the housing 5 of the operating apparatus is identical or at least partly identical to the apparatus housing 7 of the apparatus 4. This holds true particularly in disclosed embodiments in which the display surface 21 of the freely programmable display apparatus 20 covers or occupies more than half of a lateral surface, optionally a largest lateral surface in terms of surface area. Tablet computers, smartphones, PDAs shall be mentioned here by way of example for such disclosed embodiments. A central computer 200 of the apparatus 4 is then arranged spatially in the housing 5 of the operating apparatus 4, the housing then also being the apparatus housing 7. The operating apparatus 1 is only one part of the apparatus 4 and other parts provide functions that are to be operated by means of the operating apparatus 1.

The operating apparatus 1 comprises an operating unit 2 having the housing 5, which is arranged or embodied in the apparatus 4 such that a touch-sensitive position detection apparatus 30 linked to a freely programmable display apparatus 20 forms an outer surface of the apparatus 4. In most disclosed embodiments, a display surface 21 of the freely programmable display apparatus 20 is fixedly connected to a touch surface 31 of the touch-sensitive position detection apparatus 30. The combination of a display surface 21 and a fixedly connected transparent touch surface 31—arranged in front thereof—of a linked touch-sensitive position detection apparatus 30 is also referred to as a touchscreen 10. At least the touch surface 31 of the touch-sensitive position detection apparatus 30 is mounted movably relative to the housing 5, optionally elastically.

A compressive force measuring apparatus 40 is coupled to the touch surface 31 or, if the touch surface is fixedly connected to the freely programmable display apparatus 20, to the touchscreen 10, and is able, in the event of a touching actuation, to measure an actuation force acting on the touch surface 31 perpendicular to the latter. By way of example, one or a plurality of sensor elements 41 can be connected to the touch surface 31, the sensor elements, in the event of a deflection of the touch surface 31, generating a signal that is converted by a pressure measuring control device 45 into a compressive force signal 46 indicating the press-on force or actuation force determined. Furthermore, at least one actuator device 50 comprising an actuator 51 controlled by an actuator control device 55 is coupled to the touch surface 31 or, if the touch surface 31 is fixedly connected to the display surface 21, to the touchscreen 10.

The operating apparatus 1 furthermore comprises a haptic control device 100, which is arranged in the housing 5 and which is connected at least to the pressure measuring control device 45, i.e. the compressive force measuring apparatus 40, and the actuator control device 55, i.e. to the actuator device 50. The haptic control device 100 is designed to generate actuator activation signals 106 on the basis of the detected press-on forces, the actuator activation signals then being converted by the actuator controller 55 such that the actuator 51 deflects the touch surface 31 of the touch-sensitive position detection apparatus 30, such that a haptically perceptible effect arises.

In at least one disclosed embodiment, the haptic control device 100 checks the detected press-on force or actuation force relative to a first force threshold or a first force threshold value. If the force threshold or the first force threshold value is reached or exceeded, then a first actuator activation signal 106 is generated, which brings about a first haptic feedback via the actuator control device 55 and the actuator 51 at the touch surface 31. If subsequently, after the first force threshold or the first force threshold value was reached or exceeded once by the detected press-on or actuation force, a second force threshold or a second force threshold value, which is lower than the first force threshold value, is undershot, a second actuator activation signal 106 is generated, which brings about a second haptic detectable effect at the touch surface 51 via the actuator control device 55 and the actuator 51. Optionally, the two detectable haptic effects are different, such that a user can differentiate between them. Optionally, the haptic effects are embodied as short, as far as possible single deflections of the touch surface. These may differ with regard to the deflection amplitude, wherein the deflection amplitude may be greater in the case of the haptic effect generated by the first actuator activation signal than in the case of the haptic effect initiated by the second actuator activation signal.

Other disclosed embodiments comprise an improved haptic controller analogous to those which have already been explained above in association with the other disclosed embodiments. Furthermore, the other technical features of this disclosed embodiment which have the same reference signs as features of the other disclosed embodiments are also technically identical as in the other disclosed embodiments.

It is evident to the person skilled in the art that various possibilities for configuration of the disclosed embodiments are possible. What is essential is that the controller comprises a logic which evaluate a first and a second force threshold different therefrom and two haptic feedbacks brought about separately from one another are generated, which are perceptible to the user separately. They may be embodied in a pulselike fashion, such that in each case only a pulselike deflection from the rest position, optionally in a manner counteracting the user's press-on force, are caused. Furthermore, acoustic signals or sounds may be output in a temporally synchronized fashion, locally adjacently to the touch surface of the operating apparatus, such that on account of the spatial hearing perception an origin of the sound is assigned to the touch position and the entire sensory perception is thus improved for a human user to simulate a physical button. As explained thoroughly above, the controller can be implemented firstly in the local operating unit in which the touchscreen or the touch-sensitive position detection apparatus is mounted elastically movably, or in interaction with a central computer accommodated in a manner spatially remote from the touchscreen in the vehicle. Mixed forms of the distribution of the logic and controller are possible. Both in the central computer and in local control devices, parts of the logic can be implemented by means of software in interaction with a microprocessor.

In modern motor vehicles a multiplicity of functions and vehicle systems need to be operated. Since structural space in the vehicle is limited and, consequently, an individual operating element assigned to the specific functions and to the vehicle system cannot be embodied and arranged for every vehicle system and every vehicle function, it is customary nowadays for a multiplicity of such vehicle systems and operating functions to be operated or made operable via a multifunction display and operating apparatus. Such multifunction display and operating apparatuses, which are typically arranged in a center console of a motor vehicle, generally comprise a freely programmable display surface and physically embodied operating elements such as pushbuttons, rotary pulse generators or the like arranged adjacent to the display surface. By means of a graphical representation on the freely programmable display surface, functions assigned to the individual physically embodied operating elements in different display and operating contexts can be displayed graphically. Such graphical representations are referred to as operating element assignments.

In developments of the display and operating apparatuses, a touch-sensitive position detection apparatus is assigned to the freely programmable graphical display surface. In this case, positions on a touch surface of the touch-sensitive position detection apparatus correlate with positions on the graphical display surface. If the touch surface of the touch-sensitive position detection apparatus is embodied as transparent and is arranged in front of the display surface, then the combination of freely programmable display surface and touch-sensitive position detection apparatus is referred to as a touchscreen.

While a user, in the event of an actuation of a physically embodied operating element, for example a pushbutton, obtains haptic feedback upon reaching a stop or upon snapback of a trigger mechanism, the haptic feedback also enabling blind operation of buttons particularly in motor vehicles, such a haptic feedback is not realized in conventional touchscreens.

However, the prior art discloses developments in which an actuator is coupled to the touch-sensitive position detection apparatus and/or the touchscreen. The actuator brings about a mechanical vibration or deflection to generate a palpable, that is to say haptically perceptible, feedback.

In the case of operating apparatuses equipped with a touchscreen or a remote touchpad, a further difficulty during operation, particularly in a motor vehicle, consists in the fact that on account of vibrations on an uneven roadway or the like it can happen that a user with an actuation element, for example the user's finger, touches the touch-sensitive position detection device unintentionally or at an undesired position in the preliminary stages of an actuation process. To avoid incorrect initiations, some developments provide for also determining, in addition to the touch position, a compressive force with which the actuation element presses against the touch-sensitive position detection apparatus. In these disclosed embodiments, a function initiation takes place only if a touch position is detected at a predefined location or in a predefined region assigned to a virtual operating element and at the same time a press-on force also exceeds a predefined threshold value. In this case, a function initiation and, if an actuator is coupled directly or indirectly to the touch-sensitive position detection apparatus, also an initiation of a haptic feedback take place.

DE 10 2006 012 147 A1 describes an input apparatus, in particular for a motor vehicle, wherein the input apparatus comprises a housing, a display apparatus arranged in the housing and serving for optically representing information, a touch-sensitive position detection apparatus arranged above the display apparatus and serving for inputting commands by touching the touch surface, and an actuator for moving the touch-sensitive position detection apparatus or the housing in at least one direction, wherein the housing is movable relative to the display apparatus.

DE 10 2008 035 907 A1 discloses an input appliance comprising an operating panel for being touched by an actuation element, or a finger of an operator, which is movable over the operating panel, comprising means for detecting the position and/or the movement of the actuation element or the finger on the operating panel and an evaluation unit for generating a control signal corresponding to the detected variable. The input appliance is distinguished by the fact that the operating panel is configured in a manner compliant elastically, or is mounted in a manner compliant elastically, in the touch direction from the rest position on account of a touch force generated by the actuation element or the finger and in this case acts on at least one separate pressure sensor for generating a signal proportional to the touch force and the signal thereof is fed to the evaluation unit for generating a further control signal. Furthermore, a corresponding method is described. A disclosed embodiment is shown in which an actuator for generating a haptic feedback by means of a vibration is switched on and off depending on the detected touch force. If a switch-on threshold value of the touch force is exceeded, the actuator system for generating the vibration is switched on and, in the event of a switch-off threshold value of the touch force being undershot, the actuator system for generating the vibration is switched off. The switch-on threshold value and the switch-off threshold value differ To prevent the haptic feedback from being unintentionally switched on and off in the event of a press-on force in the region of the switch-on threshold value. A “switching on-off hysteresis” is thus realized.

Although the disclosed embodiment described in the prior art improves a possibility of blind operation, the haptic feedback experienced by the user differs significantly from that which occurs for a user in the event of an actuation of a physically embodied mechanical operating element. For users not familiar with the type of haptic feedback described in DE 10 2008 035 907 A1, therefore, this type of haptic feedback leads to irritation, which, for example during the use of a hire car with which the user is not previously familiar, would lead to an adverse effect on driving safety.

### LIST OF REFERENCE SIGNS

1 Operating apparatus
2 Operating unit
3 Motor vehicle
4 Apparatus (e.g. an automatic machine, a smartphone, a control station, etc.)
5 Housing
6 Housing parts
7 Apparatus housing
10 Touchscreen
15 Touchscreen control device
20 Freely programmable display apparatus
21 Display surface
25 Display control device
30 Touch-sensitive position detection apparatus
31 Touch surface
35 Position detection control device
36 Position signal
40 Compressive force measuring apparatus
41 Sensor element
45 Pressure measuring control device
46 Compressive force signal
50 Actuator device
51 Actuator
55 Actuator control device
60 Sound generator
70 Loudspeaker
80 Operating unit control device
100 Haptic control device
106 Actuator activation signal
108 Sound activation signal
110 First comparator
116 Comparison result signal (first force threshold)
120 Second comparator
126 Comparison result signal (second force threshold)
130 Further comparator
133 Memory
136 Comparison result signal (initiation region position)
140 Haptic-logic device
150 Interface
160 Delay device
200 Central computer
210 Central computer interface
300 BUS
501 Actuation direction arrow
502 Actuator deflection direction arrow
510 Holder plate
520 Touchscreen carrier
530 Mounting element
540 L-profile
550 Leaf spring
560 Printed circuit board
570 Printed circuit board
610 Top magnet
620 Coil
621 Coil axis
630 Electronics circuit board
640 Terminals
710 Strain gage
720 Adhesive layer
810 Holding frame
820 Printed circuit board
830 Plunger
840 Plate capacitor
850 First force threshold value
860 Second force threshold value
900 Working range
910 Gradient
920 Press-on force curve
930 Driving signal
940 Deflection
950 Pulselike deflection
951 Overshoot
952 Overshoot
960 Loudspeaker signal
t1-t5 Instants
1010 Physical operating elements
1011 Pushbutton
1012 Rotary encoder
1020 Human-machine model
1030 Human-machine interface logic
1110 Defining operating mode
1120 Configuration
1130 Defining the excitation profiles
1140 Force threshold exceedance
1150 Force values
1160 Version information
1170 Touch positions/operating element signals
1210 Initialization
1220 Communicating touch position data
1230 Communicating exceedance of the first force threshold
1240 Logic evaluation
1250 Initiating first feedback
1260 Communicating undershooting of the second force threshold
1270 Further logic evaluation
1280 Initiating second feedback
1290 Function initiation
1310 Initialization
1320 Communicating touch position data
1330 Exceedance of the first force threshold detected
1340 Initiation of first feedback
1350 Communicating exceedance of the first force threshold (virtual operating element fully pressed)
1360 Identifying the undershooting of the second force threshold
1370 Initiation of second feedback
1380 Communicating undershooting of the second force threshold
1390 Function initiation

1. An operating apparatus for a motor vehicle the method comprising:
a housing;
a touchscreen, which has a display apparatus having a freely programmable display surface for representing at least one virtual operating element and a touch-sensitive position detection apparatus having a touch surface arranged in front of the display surface, wherein at least the touch surface is mounted on the housing movably relative thereto; at least one compressive force measuring apparatus for determining a press-on force acting on the touch surface in the event of a touching actuation of the touchscreen;
at least one actuator device coupled directly or indirectly to the touch surface and serving for the targeted movement of at least the touch surface relative to the housing; and
a controller designed to determine, depending on the detected touch positions and detected press-on forces, whether a correct haptic actuation of the at least one virtual operating element is present, and, if this is the case, to initiate a function assigned to the at least one virtual operating element and to drive the at least one actuator device to generate a haptic feedback at the touch surface,
wherein the controller compares the press-on forces with a first force threshold value and a second force threshold value deviating therefrom and generates a first actuator activation signal in the event of the first force threshold value being exceeded, and generates a second actuator activation signal, which is different from the first actuator activation signal, in the event of the second force threshold value subsequently being undershot,
wherein the first and second actuator activation signals instigates in each case a haptic feedback at the touch surface via the actuator device, and
wherein the haptically perceptible feedbacks generated by the first actuator activation signal and the second actuator activation signal at the touch surface are different, wherein the controller generates the haptic feedbacks in each case in the form of a short mechanical pulse.

2. The operating apparatus of claim 1, wherein the controller selects the at least one function as function to be initiated if the detected touch position lies in an initiation region of the at least one virtual operating element that is assigned to the at least one virtual operating element, and generates the haptic feedbacks only if the at least one function is selected as function to be initiated.

3. The operating apparatus of claim 1, wherein a loudspeaker is arranged on or in the housing and the controller has a sound generator and drives said sound generator so a sound signal is output via the loudspeaker so the sound signal is temporally synchronized with a deflection of the touch surface caused by the first haptic feedback.

4. The operating apparatus of claim 1, wherein the controller is designed so a sound signal is in each case output both with the first haptic feedback and with the second haptic feedback.

5. The operating apparatus of claim 4, wherein the sound signals that are output for the first haptic feedback and the second haptic feedback are different.

6. A method for operating functions, the method comprising:
representing a virtual operating element on a display surface;
detecting touch positions on a touch surface of a touch-sensitive position detection apparatus, the touch surface being coupled to the display surface;
detecting press-on forces in the event of a touching actuation of the touch surface; and
evaluating the detected touch positions and press-on forces and determining whether a correct haptic actuation of the virtual operating element is present, and, if this is the case, initiating a function assigned to the at least one virtual operating element, and generating a haptic feedback at the touch surface,
wherein the press-on forces determined are compared with a first force threshold value and a second force threshold value and a first haptic feedback is generated at the touch surface in the event of the first force threshold value being exceeded, and a second haptic feedback, which deviates from the first haptic feedback, is subsequently generated at the touch surface in the event of the second force threshold value being undershot, wherein the first haptic feedback the second haptic feedback are embodied as pulselike deflections of the touch surface.

7. The method of claim 6, wherein the haptic feedback is generated only if the detected touch position lies in an initiation region of the at least one virtual operating element assigned to the at least one virtual operating element.

8. The method of claim 6, wherein an acoustic sound signal is output in a temporally synchronized manner at least with the first haptic feedback or the second haptic feedback.

9. The method of claim 8, wherein the acoustic sound signal is output spatially adjacently to the touch surface.

10. The method of claim 8, wherein the temporally synchronized outputting of the sound signal is performed so a maximum deflection of the touch surface coincides temporally with the beginning of the acoustic sound signal that is output, such that a user who uses a finger as actuation element perceives the haptic feedback simultaneously with the beginning of the acoustic sound signal.

11. The method of claim 6, wherein the assigned function is a function in a motor vehicle.

12. An operating apparatus, comprising:
a housing;
a touchscreen, which has a display apparatus having a freely programmable display surface for representing at least one virtual operating element and a touch-sensitive position detection apparatus having a touch surface arranged in front of the display surface, wherein at least the touch surface is mounted on the housing movably relative thereto;
at least one compressive force measuring apparatus for determining a press-on force acting on the touch surface in the event of a touching actuation of the touchscreen;
at least one actuator device coupled directly or indirectly to the touch surface and serving for the targeted movement of at least the touch surface relative to the housing; and
a controller designed to determine, depending on the detected touch positions and detected press-on forces, whether a correct haptic actuation of the at least one virtual operating element is present, and, if this is the case, to initiate a function assigned to the at least one virtual operating element and to drive the at least one actuator device to generate a haptic feedback at the touch surface,
wherein the controller is designed to compare the press-on forces with a first force threshold value and a second force threshold value deviating therefrom and to generate a first actuator activation signal in the event of the first force threshold value being exceeded, and to generate a second actuator activation signal, which is different from the first actuator activation signal, in the event of the second force threshold value subsequently being undershot,
wherein the first and second actuator activation signals instigate in each case a haptic feedback at the touch surface via the actuator device, and
wherein the haptically perceptible feedbacks generated by the first actuator activation signal and the second actuator activation signal at the touch surface are different, wherein the controller generates the haptic feedbacks in each case in the form of a short mechanical pulse.

13. The operating apparatus of claim 12, wherein the housing has a fixing device, wherein the fixing device is fixed on an apparatus from the group of the following apparatuses consisting of: a vehicle or aircraft, a ship, an automatic ticket or other vending or information machine, a computer, a cellular phone, a tablet computer, a production or process installation, a control station, a domestic appliance or an appliance appertaining to consumer electronics.
